(19) United States
(12) Patent Application Publication
(10) Pub. No.: US 2018/0005319 A1
(43) Pub. Date: Jan. 4, 2018

(54) Risk-Aware Dynamic Pricing of Long-Term Contracts

(71) Applicant: International Business Machines Corporation, Armonk, NY (US)

(72) Inventors: Markus Ettl, Ossining, NY (US); Yan Shang, Sunnyvale, CA (US); Shivaram Subramanian, New Fairfield, CT (US); Zhengliang Xue, Yorktown Heights, NY (US)

(21) Appl. No.: 15/199,331

(22) Filed: Jun. 30, 2016

(51) Int. Cl. G06Q 40/04

(52) U.S. Cl. CPC G06Q 40/04

(57) ABSTRACT

Systems, methods, and computer-readable media are disclosed for optimizing terms of a long-term contract between a buyer and a seller for a product. Various types of forecasting models may be generated and used to determine the optimized terms such as an optimized price for the long-term contract. A risk model may be generated and evaluated to identify market disruptions that indicate that the optimized price should be re-negotiated to distribute the associated risk between the buyer and seller. An example of such a market disruption may be a market price fluctuation that causes a difference between a spot market price for the product and a contract price to meet or exceed a threshold value.

### BACKGROUND

A buyer seeking a long-term relationship with a seller may enter into a long-term contract with pre-negotiated prices in order to establish a pricing mechanism over time. Such long-term contracts mitigate high volatility in the spot market environment. Existing techniques for evaluating and accounting for the risk associated with the dynamic evolution of the market environment over an extended period of time when determining the price of a long-term contract suffer from a number of drawbacks, technical solutions to which are described herein.

### SUMMARY

In one or more example embodiments of the disclosure, a method is disclosed for determining optimized terms of a long-term contract for a product. The method includes receiving, from a buyer, a quote request for the long-term contract to purchase the product from a seller and determining a buyer segment to which the buyer belongs. The method further includes determining various models including a spot market price forecast model that forecasts a spot market price of the product on a spot market, a demand forecast model that forecasts an amount of the product purchased by the buyer under the long-term contract based on terms of the long-term contract and the spot market price, and a contract optimization model based at least in part on the spot market price forecast model and the demand forecast model. The method then includes determining the optimized terms of the long-term contract including at least an optimized price, a buyer quantity commitment, and risk-aware terms using the contract optimization model and sending an indication of the optimized terms to the buyer.

In one or more other example embodiments of the disclosure, a system is disclosed for determining optimized terms of a long-term contract for a product. The system includes at least one memory storing computer-executable instructions and at least one processor configured to access the at least one memory and execute the computer-executable instructions to perform a set of operations. The operations include receiving, from a buyer, a quote request for the long-term contract to purchase the product from a seller and determining a buyer segment to which the buyer belongs. The operations further include determining various models including a spot market price forecast model that forecasts a spot market price of the product on a spot market, a demand forecast model that forecasts an amount of the product purchased by the buyer under the long-term contract based on terms of the long-term contract and the spot market price, and a contract optimization model based at least in part on the spot market price forecast model and the demand forecast model. The operations then include determining the optimized terms of the long-term contract including at least an optimized price, a buyer quantity commitment, and risk-aware terms using the contract optimization model and sending an indication of the optimized terms to the buyer.

In one or more other example embodiments of the disclosure, a computer program product for determining optimized terms of a long-term contract for a product is disclosed that comprises a non-transitory storage medium readable by a processing circuit, the storage medium storing instructions executable by the processing circuit to cause a method to be performed. The method includes receiving, from a buyer, a quote request for the long-term contract to purchase the product from a seller and determining a buyer segment to which the buyer belongs. The method further includes determining various models including a spot market price forecast model that forecast a spot market price of the product on a spot market, a demand forecast model that forecasts an amount of the product purchased by the buyer under the long-term contract based on terms of the long-term contract and the spot market price, and a contract optimization model based at least in part on the spot market price forecast model and the demand forecast model. The method then includes determining the optimized terms of the long-term contract including at least an optimized price, a buyer quantity commitment, and risk-aware terms using the contract optimization model and sending an indication of the optimized terms to the buyer.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. In the drawings, the left-most digit(s) of a reference numeral identifies the drawing in which the reference numeral first appears. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1 is a schematic block diagram illustrating various components of a dynamic contract optimization system in accordance with one or more example embodiments of the disclosure.

FIG. 2 is a process flow diagram of a method for determining optimized terms for a long-term contract including an optimized contract price in accordance with one or more example embodiments of the disclosure.

FIG. 3 is an example use case in accordance with one or more example embodiments of the disclosure.

FIG. 4 is a schematic diagram of an illustrative networked architecture in accordance with one or more example embodiments of the disclosure.

### DETAILED DESCRIPTION

A long-term contract between a buyer and a seller typically specifies 1) a negotiated price at which the seller is obligated to sell a product to the buyer 2) a committed quantity (also referred to herein as a minimum committed amount) that the buyer is obligated to purchase from the seller under the long-term contract, 3) risk-aware terms under which the long-term contract may be re-negotiated to accommodate any significant change in market conditions and 4) a contract term indicative of a period of time over which the seller is obligated to sell the product to the buyer at the negotiated price. A long-term contract also typically specifies a total amount of the product that the seller is obligated to deliver to the buyer if requested by the buyer. While the buyer is required to purchase the minimum committed amount at the negotiated price of the long-term contract, the buyer is free to purchase any additional needed amount at a spot market price. A buyer may turn to the spot market when the spot market price is less than the negotiated price of the long-term contract.

Example embodiments of the disclosure include, among other things, systems, methods, computer-readable media, techniques, and methodologies for determining optimized terms for a long-term contract between a buyer and a seller for a product, where the optimized terms include at least an optimized price for the product, determining whether the terms of the long-term contact (e.g., the contract price) should be re-negotiated based at least in part on a risk model that assesses the impact of market disruptions, and determining an updated contract terms for the long-term contract including, for example, an updated optimized price when market disruptions indicated by the risk model satisfy threshold criteria. It should be appreciated that the term product may be used herein to generically refer to any good, service, or the like that may be exchanged between a seller and a buyer. Further, while example embodiments of the disclosure may be described hereinafter in connection with determining an optimized price of a product under a long-term contract, it should be appreciated that other optimized terms such as, for example, a minimum committed amount, risk-aware contract terms, etc. may be similarly determined.

More specifically, in example embodiments of the disclosure, various types of forecasting models may be generated and used to determine the optimized price for a long-term contract. A risk model may be generated and evaluated to identify market disruptions that indicate that the optimized price should be re-negotiated to distribute the associated risk between the buyer and seller. An example of such a market disruption may be a market price fluctuation that meets or exceeds a threshold value.

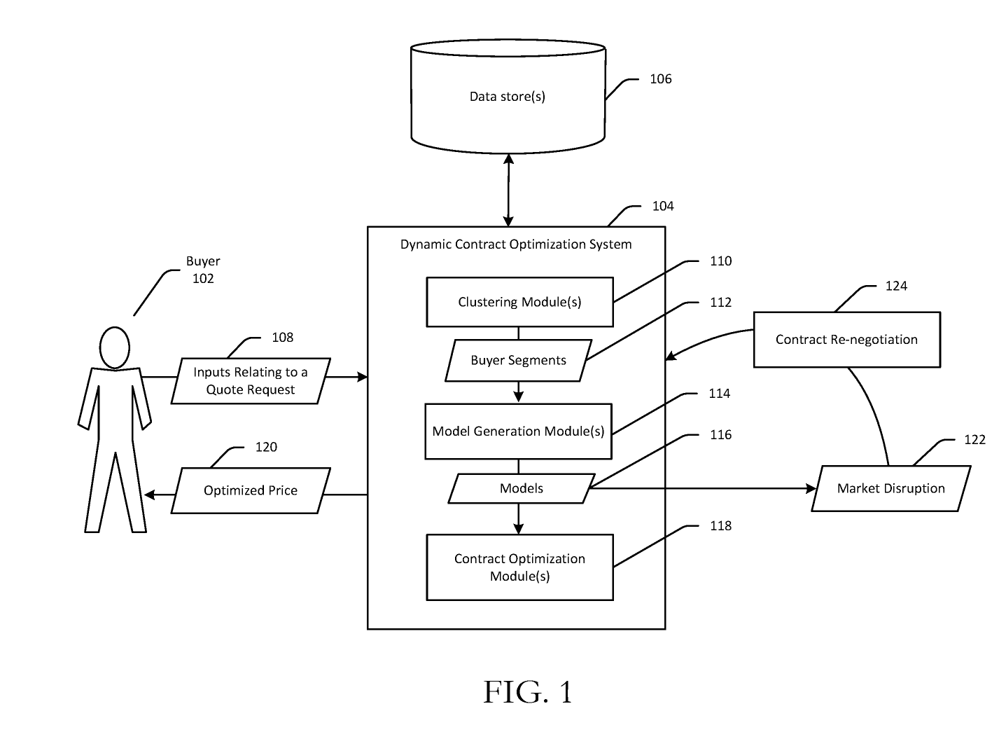

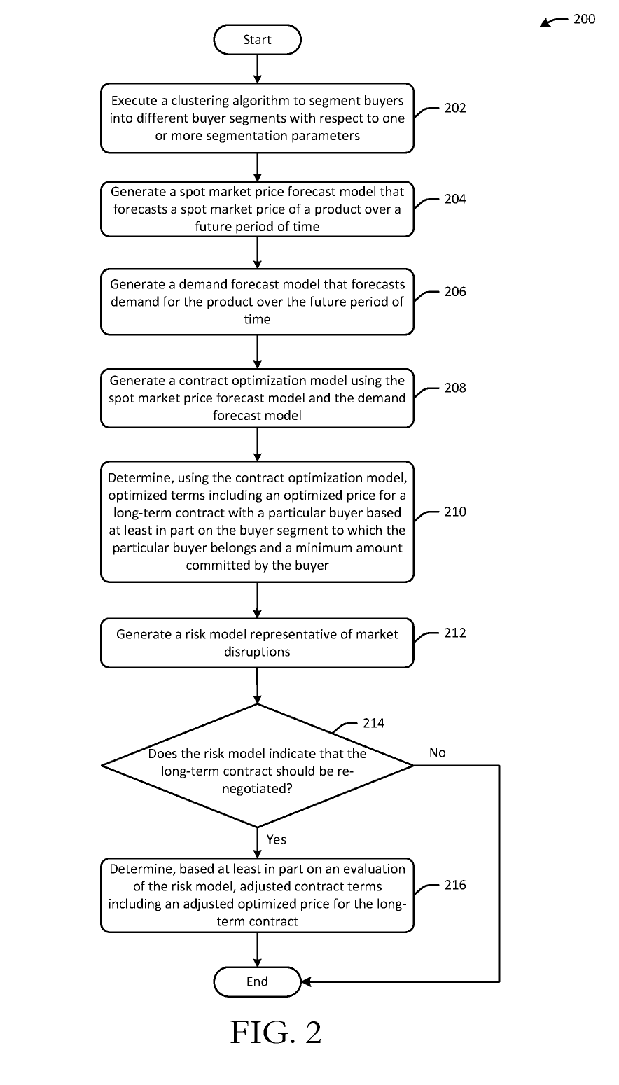

FIG. 1 is a schematic block diagram illustrating various components of a dynamic price optimization system 104 in accordance with one or more example embodiments of the disclosure. FIG. 2 is a process flow diagram of a method 200 for determining optimized terms (e.g., price-related terms) for a long-term contract in accordance with one or more example embodiments of the disclosure. FIGS. 1 and 2 will be described in conjunction with one another hereinafter.

One or more operations of the method 200 may be performed by one or more program modules or sub-modules forming part of such module(s). A program module, which may itself contain or be a collection of one or more sub-modules, may include computer-executable instructions that when executed by a processing circuit may cause one or more operations to be performed. A processing circuit may include one or more processing units or nodes. Computer-executable instructions may include computer-executable program code that when executed by a processing unit may cause input data contained in or referenced by the computer-executable program code to be accessed and processed to yield output data. Any program module described herein may be implemented in any combination of software, hardware, and/or firmware.

Referring first to FIG. 1, a dynamic contract optimization system 104 is depicted that includes one or more clustering modules 110, one or more model generation modules 114, and one or more contract optimization modules 118. The dynamic contract optimization system 104 may be configured to read from and write to one or more data stores 106. The dynamic contract optimization system 104 may be configured to implement the method 200 of FIG. 2.

The method 200 may be performed to determine optimized terms for a long-term contract for a product between a buyer and a seller. The optimized terms may include an optimized price, a minimum committed amount, risk-aware terms, and/or any other price-related contract terms. A buyer may seek to enter into a long-term contract with a seller of a product in order to establish a reliable pricing mechanism over time and to mitigate against high volatility in the spot market environment. Further, when entering into a long-term contract, a seller needs to account for the risk associated with the dynamic evolution of the market environment over an extended period of time. As such, the method 200 may also be performed to determine when market disruptions associated with the dynamic evolution of the market environment necessitate re-negotiation of the long-term contract terms (e.g., price) in order to balance the risk between the buyer and the seller.

Referring now to FIGS. 1 and 2 in conjunction with one another, at block 202, computer-executable instructions of the clustering module(s) 110 may be executed to cause a clustering algorithm to be executed to segment buyers into different buyer segments 112 with respect to one or more segmentation parameters. The clustering algorithm may be, for example, a hierarchical clustering algorithm. Buyers segmented into a same buyer segment 112 may exhibit shared attributes with respect to one or more segmentation parameters.

The segmentation parameters may include, without limitation, a pricing mechanism (e.g., spot market pricing vs. contract pricing); product features; firmographic attributes (e.g., market share controlled by the buyer, size of the buyer in terms of market capitalization or some other metric, industry of the buyer, etc.); and so forth. Data related to the segmentation parameter(s) may be accessed from the data store(s) 106. Such data may include, without limitation, customer relationship management (CRM) data, historical request for quote (RFQ) data, supply chain data, external market data (e.g., credit rating data, import/export data, etc.), and so forth.

Buyers segmented into the same buyer segment 112 may be presumed to react in a similar manner to market price fluctuations. For example, buyers segmented into the same buyer segment 112 may be similarly inclined to turn to the spot market for fulfilling a desired amount of a product for a certain type of spot market price fluctuation (e.g., a convex price decrease, a concave price decrease, etc.).

In addition to clustering buyers into different buyer segments, the clustering module(s) 110 may further determine different product segments based on various product attributes such as, for example, the industry to which a product relates, the type of product, etc. In certain example embodiments, the clustering module(s) 110 may also segment historical price quotes based on the type of pricing mechanism (e.g., spot market vs. contract pricing). The various types of segmentation described above may be used to determine an appropriate set of models to use for a given buyer segment, product segment, etc. in order to determine optimized terms (e.g., an optimized price) for a long-term contract. The types of models that may be generated will be described hereinafter in more detail.

The operations at blocks 204-208 may be performed to generate a set of models 116 that may be used to determine optimized terms (e.g., an optimized price) for a long-term contract for the purchase of a product by a buyer (e.g., a buyer 102) from a seller. More specifically, at block 204, computer-executable instructions of the model generation module(s) 114 may be executed to generate a spot market price forecast model that forecasts the trajectory of a spot market price of a product over a future period of time. In certain example embodiments, the spot market price forecast model may be based at least in part on historical price information associated with the product. Further, in certain example embodiments, the spot market price forecast model may be a vector-based time series model.

At block 206, computer-executable instructions of the model generation module(s) 116 may be executed to generate a demand forecast model that forecasts demand over the future period of time, or more specifically, an amount of the product purchased by the buyer under the long-term contract based on terms of the long-term contract and the spot market price. In certain example embodiments, the demand forecast model may account for price influencers whose price may impact the demand of the product. For example, product A may be a precursor product needed to generate product B. In such a scenario, the demand forecast model for product B may take into account a forecasted price for product A. In certain example embodiments, the demand forecast model may be vector-based time series model.

At block 208, computer-executable instructions of the contract optimization module(s) 118 may be executed to generate a multiple period contract optimization model using the spot market price forecast model and the demand forecast model. In certain example embodiments, the contract optimization model may be a dynamic program. Then, at block 210, computer-executable instructions of the contract optimization module(s) 118 may be executed to determine, using the contract optimization model, optimized terms including an optimized price for a long-term contract between a buyer 102 and a seller of a product based at least in part on the buyer segment 112 to which the buyer 102 belongs and a minimum amount of product that the buyer 102 has committed to buy under the long-term contract.

More specifically, the buyer 102 may submit a quote request 108 to the contract optimization system 104. The quote request 108 may include various inputs such as, for example, one or more attributes of the buyer 102, one or more attributes of the desired product, a minimum amount of product that the buyer 102 will commit to buying, and so forth. Upon receiving the quote request 108, the contract optimization system 104 may determine the buyer segment 112 to which the buyer 102 belongs. The contract optimization module(s) 118 may then determine, based at least in part on the determined buyer segment 112, the appropriate contract optimization model to use to determine optimized terms including an optimized price 120 for a long-term contract between the buyer 102 and a seller of the product.

In certain example embodiments, determining the optimized price 120 may include solving the following equation. The contract price determined using the following equation may be applicable to a long-term contract spanning T time periods.

$${max}_{p} ( {p}^{c} - {c}_{t} ) {w}_{t} Pr ( {u}_{t} ( {p}^{c} , {p}_{t}^{s} , {x}_{t} ) ) + ( {p}^{c} - {\hat{c}}_{t + 1} ) {\hat{w}}_{t + 1} Pr ( {u}_{t + 1} ( {p}^{c} , {\hat{p}}_{t + 1}^{s} , {\hat{x}}_{t + 1} ) ) + … + ( {p}^{c} - {\hat{c}}_{t + T} ) {\hat{w}}_{t + T} Pr ( {u}_{t + T} ( {p}^{c} , {\hat{p}}_{t + T}^{s} , {\hat{x}}_{t + T} ) )$$

$${w}_{t} Pr ( {u}_{t} ( {p}^{c} , {p}_{t}^{s} , {x}_{t} ) ) + … + {\hat{w}}_{t + T} Pr ( {u}_{t + T} ( {p}^{c} , {\hat{p}}_{t + T}^{s} , {\hat{x}}_{t + T} ) \geq {w}^{c} ( t , t + T )$$

In the above equation, p^{c} may represent the optimized contact price 120 to be determined; p^{s} may represent the spot market price (which may be determined for each of T time periods); c may represent the cost of the product (which may be determined for each of the T time periods); w may represent the maximum quantity that can be purchased a given time period (which may be determined for each of the T time periods); x may represent a vector of environment variables indicative of an impact of industry factors on price/demand forecasts (which may be determined for each of the T time periods); and Pr may represent the probability (or share) of purchase of the product from the contract with a seller. The ̂ character is used to determine any quantity that is forecasted for a future time period. In summary, the above equation may be solved to determine the optimized price 120 that maximizes the sum of the respective probability of purchase of the product for each time period multiplied by the maximum amount of the product that may be purchased in each time period. The constraint w^{c}(t,t+T) may represent the minimum quantity a buyer has committed to purchase from period t to period t+T.

The method 200 may then proceed to block 212 where computer-executable instructions of the model generation module(s) 114 may be executed to generate a risk model representative of market disruptions associated with the product. In certain example embodiments, the risk model may be a supervised learning model that utilizes machine learning to determine a probability estimation of exogenous events that indicate market disruptions. The risk model may be, for example, a Markov modulated multi-period dynamic program model. Such market disruptions may include, without limitation, a convex change (e.g., a plunge or surge) in the spot market price of the product, a concave change (e.g., plunge or surge) in the spot market price, and so forth. A convex decrease may correspond to a sharp decline in the spot market price of a product at the beginning over a given period of time. On the other hand, a concave decrease may correspond to a relatively less steep decline at the beginning in the spot market price over the period of time. Market disruptions that cause significant changes in the spot market price of a product may be caused by a variety of factors including, without limitation, large changes in supply or demand for the product, shortages of raw materials or other precursor products, etc.

At block 214, computer-executable instructions of the contract optimization module(s) 118 may be executed to determine whether the risk model indicates that terms of the long-term contract (e.g., the optimized price 120) should be re-negotiated. For example, at block 214, the contract optimization module(s) 118 may determine whether a market disruption 122 has occurred that necessitates re-negotiation 124 of the optimized long-term contract price 120 in order to allow the seller to balance the risk associated with the market disruption 122 with the buyer 102. The market disruption may be, for example, a decline in the spot market price by at least a threshold value.

In response to a negative determination at block 214, the contract terms (e.g., the optimized price 120) for the long-term contract may remain the same, and the method 200 may end. On the other hand, in response to a positive determination at block 214, the contract optimization module(s) 118 may determine, at block 216, adjusted contract terms including an adjusted optimized price for the long-term contract based at least in part on an evaluation of the risk model.

In certain example embodiments, the risk model may be dynamic program given by the following equation.

$${G}_{t} ( {p}_{t}^{c} , {p}_{t}^{s} , {x}_{t} ) = {max}_{p} {\sum }_{τ = t}^{t + z ( L - 1 )} \{ ( ( 1 - z ) p + {zp}_{t}^{c} - {c}_{τ} ) {w}_{τ} Pr ( {u}_{τ} ( ( 1 - z ) p + {zp}_{τ}^{c} , {\hat{p}}_{τ}^{s} , {\hat{x}}_{τ} ) ) \} + γ {EG}_{t + zL} ( p , {\hat{p}}_{t + zL}^{s} , {\hat{x}}_{t + zL} )$$

$${\sum }_{τ = t}^{t + z ( L - 1 )} {w}_{τ} Pr ( {u}_{τ} ( {\hat{p}}_{τ}^{s} , ( 1 - z ) p + {zp}_{t}^{c} , {\hat{x}}_{τ} ) ) + {\sum }_{τ = t + zL}^{t + T} {w}_{τ} Pr ( {u}_{τ} ( {\hat{p}}_{τ}^{s} , p , {\hat{x}}_{τ} ) ) \geq {\overline{w}}_{t}^{c} ( t , t + T ) \\ z = Indicator ( {p}_{t}^{s} - {p}_{t}^{c} \geq Δ p )$$

The term Gₜ may represent a seller's total expected profit from period t to t+T. The term p may represent a re-negotiated optimized price for the long-term contract, p^{c} may represent the current optimized price for the long-term contract, and p^{s} may represent the spot market price. The variable z may represent a specified risk condition on an upward price adjustment of the long-term contract such that a re-negotiation of the long-term contract will start if a difference between the current spot market price and the contract price is above a threshold Δp. The price adjustment variable z may be related to the re-negotiated price as follows: z=1 if p>pₜ^{c}; z=0 if p≦pₜ^{c}. Thus, if the re-negotiated price will be above the current optimized contract price 120, the z term=1, and the term p(1−z) goes to zero, indicating that the contract price 120 should remain the same from time period t to time period t+L−1, for any 1≦L≦T, which is a time window of price protection against instant price increase. After the time window of protection, the contract price will switch to the re-negotiated one from period t+L to t+T. On the other hand, if the risk condition is not satisfied, the seller is unable to increase the price of the long-term contract, the z term=0, and the term zpₜ^{c} becomes zero, thereby indicating that the contract price p will be no more than pₜ^{c} 120. Meanwhile, seller's price decrease will be valid immediately. The above-described method is not limited to a protection from instant price increase. If necessary, a protection window against decrease may be similarly established.

Example embodiments of the disclosure include or yield various technical features, technical effects, and/or improvements to technology. For instance, example embodiments of the disclosure provide the technical effect of automated determinations of when risk conditions are satisfied to trigger automated re-negotiation of contract terms. This technical effect is achieved as a result of the technical features of generating multiple different models to forecast the spot market price and demand of a product, to optimize contract terms based on the forecasts, and to assess risk in relation to the spot market price in order to determine when re-negotiation of contract terms (e.g., contract price) should be automatically triggered. Thus, example embodiments of the disclosure improve the functioning of a computer with respect to the optimization of contract terms of a long-term contract. It should be appreciated that the above examples of technical features, technical effects, and improvements to the functioning of a computer and computer technology provided by example embodiments of the disclosure are merely illustrative and not exhaustive.

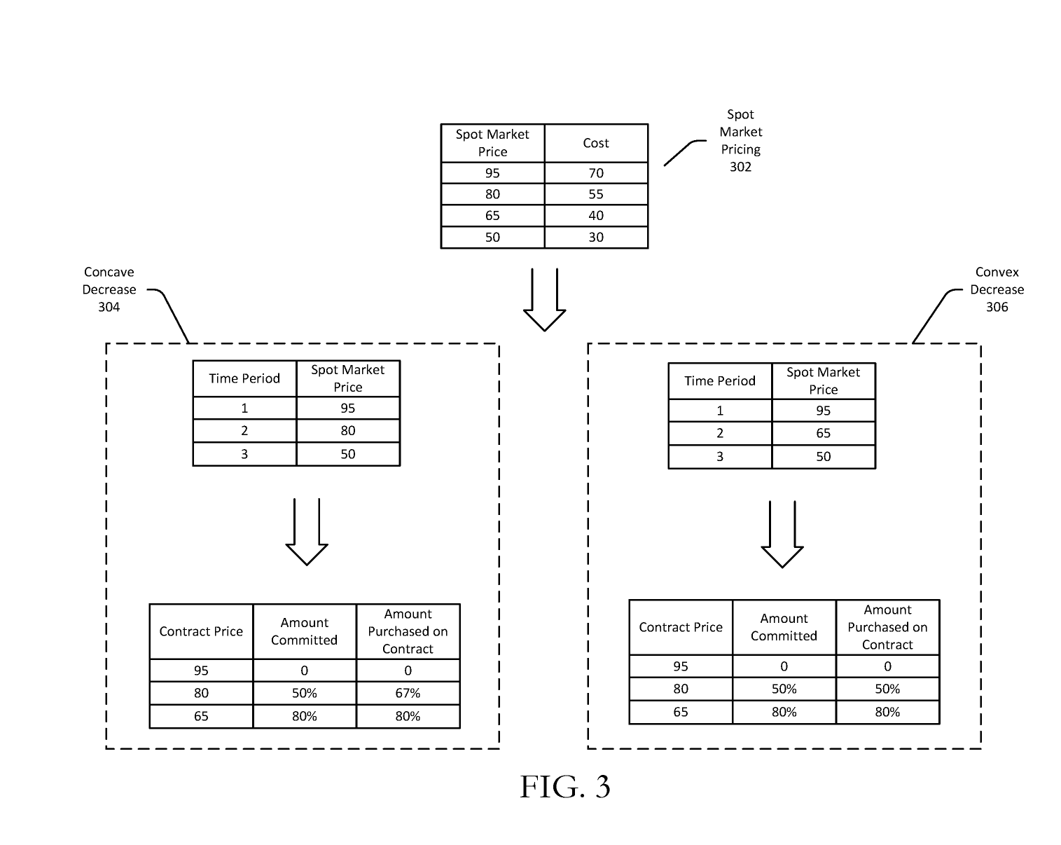

FIG. 3 is an example use case in accordance with one or more example embodiments of the disclosure. FIG. 3 depicts spot market pricing 302 for a product that includes a series of spot market prices and associated costs of the product to a seller for four different time periods. FIG. 3 further depicts two different price scenarios—a concave decrease 304 in the spot market price of the product and a convex decrease 306 in the spot market price of the product. For each scenario, three different time periods are shown with a corresponding spot market price for each time period. Further, for each scenario, for a given contract price and a given committed amount of product, a corresponding amount of product actually purchased on the contract is shown.

More specifically, for both the concave decrease scenario 304 and the convex decrease scenario 306, the percentage of product demand purchased by the buyer on the contract is zero if the committed amount is zero and the contract price is 95 since the buyer can obtain the product for the same or a lower price on the spot market in each time period. Further, for both the concave decrease scenario 304 and the convex decrease scenario 306, the percentage of product demand purchased by the buyer on the contract is 80% since the buyer will purchase 33.3% of the total demand under the contract for each of time periods 1 and 2 (because the contract price does not exceed the spot market price during time periods 1 and 2), but will only purchase 13.3% of the total demand under the contract for time period 1 in order to meet the committed amount. The buyer will purchase the remaining 20% of the total demand from the spot market in time period 3. In either scenario, if the contract price is 65 and the committed amount is 80%, the profit to the seller is given by: 33.3%(65−70)+33.3%(65−40)+13.3%(65−30).

However, if the contract price is 80 and the committed amount is 50%, the percentage of total demand purchased by the buyer under the contract differs for the two scenarios. In particular, in the concave decrease scenario 304, the buyer purchases 33.3% of the total demand in time period 1 since the contract price is less than the spot market price in time period 1. The buyer purchases the entire portion of the total demand available to purchase in time period 2 as well (33.3%) since the contract price does not exceed the spot market price in time period 2. Thus, the buyer ends up purchasing a greater percentage (66.6%) of the total demand than the committed amount in the concave decrease scenario 304.

In the convex decrease scenario 306, however, the buyer only buys the committed amount of 50% when the contract price is 80. This is so because the contract price is greater than the spot market price in time period 2 in the convex decrease scenario 306, and thus, the buyer only buys 16.6% of the total demand in time period 2 and obtains the remaining 16.6% from the spot market in time period 2. In either scenario, when the contract price is 80 and the committed amount is 50%, the buyer purchases no product under the contract in time period 3 and obtains everything in time period 3 from the spot market.

The convex decrease scenario 306 represents a sharper decline in the spot market price of the product from time period 1 to time period 2 as compared to the concave decrease scenario 304. Thus, in accordance with example embodiments of the disclosure, it may be determined that the contract price should be re-negotiated under the convex decrease scenario 306 but not under the concave decrease scenario 304 if the contract price is 80. In other example embodiments, the contract price may be re-negotiated in either scenario if the contract price is 80, but may simply be updated earlier in the convex decrease scenario 306 as compared to the concave decrease scenario 304.

One or more illustrative embodiments of the disclosure are described herein. Such embodiments are merely illustrative of the scope of this disclosure and are not intended to be limiting in any way. Accordingly, variations, modifications, and equivalents of embodiments disclosed herein are also within the scope of this disclosure.

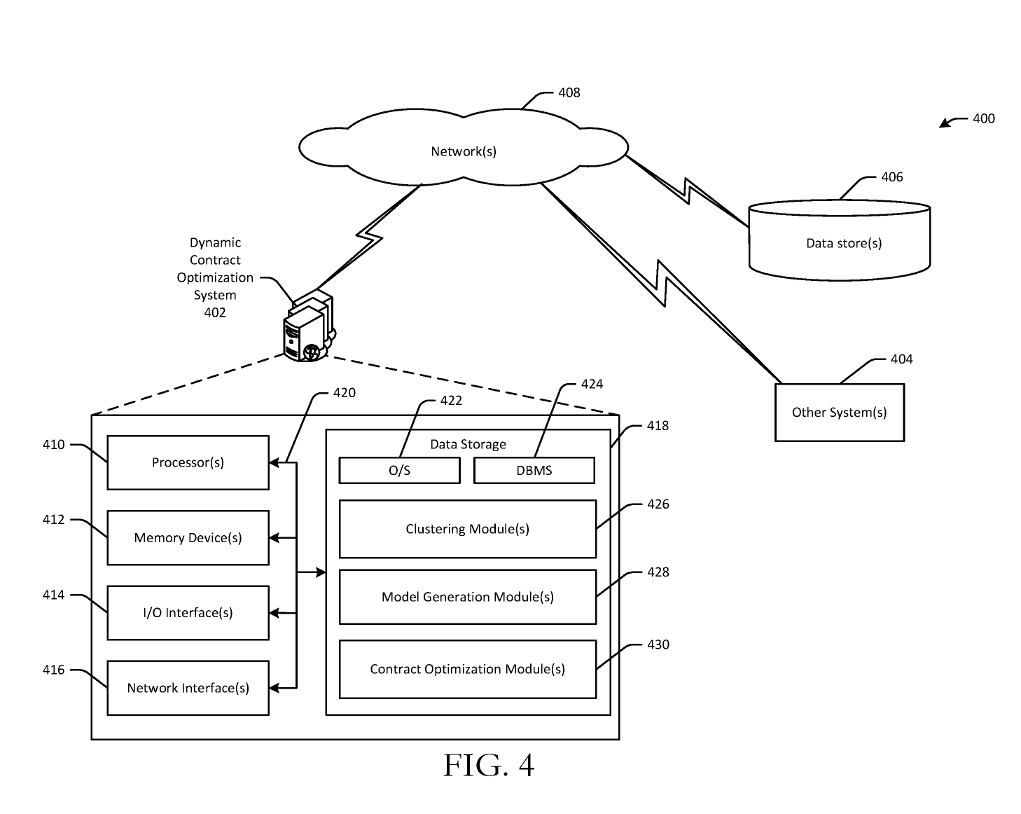

FIG. 4 is a schematic diagram of an illustrative networked architecture 400 in accordance with one or more example embodiments of the disclosure in accordance with one or more example embodiments of the disclosure. The networked architecture 400 may include a dynamic contract optimization system 402 that may include one or more dynamic contract optimization servers. The dynamic contract optimization system 402 may be configured to communicate with one or more other systems 404 via one or more networks 408. The other system(s) 404 may include, for example, a CRM system, a historical sales/price quote system, a supply chain data system, an external market system, or the like. In addition, the dynamic contract optimization system 402 may be configured to access one or more data stores 406 over the network(s) 408. The data store(s) 406 may include any of the data previously described in connection with the data store(s) 106, special pricing rules, or the like. It should be appreciated that functionality described in connection with the dynamic contract optimization system 402 may be distributed across multiple dynamic contract optimization servers in a distributed fashion.

The network(s) 408 may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. The network(s) 408 may have any suitable communication range associated therewith and may include, for example, global networks (e.g., the Internet), metropolitan area networks (MANs), wide area networks (WANs), local area networks (LANs), or personal area networks (PANs). In addition, the network(s) 408 may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the dynamic contract optimization system 402 may include one or more processors (processor(s)) 410, one or more memory devices 412 (generically referred to herein as memory 412), one or more input/output (“I/O”) interface(s) 414, one or more network interfaces 416, and data storage 418. The dynamic contract optimization system 402 may further include one or more buses 420 that functionally couple various components of the dynamic contract optimization system 402.

The bus(es) 420 may include at least one of a system bus, a memory bus, an address bus, or a message bus, and may permit exchange of information (e.g., data (including computer-executable code), signaling, etc.) between various components of the dynamic contract optimization system 402. The bus(es) 420 may include, without limitation, a memory bus or a memory controller, a peripheral bus, an accelerated graphics port, and so forth. The bus(es) 420 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

The memory 412 of the dynamic contract optimization system 402 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 412 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 412 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 418 may include removable storage and/or non-removable storage including, but not limited to, magnetic storage, optical disk storage, and/or tape storage. The data storage 418 may provide non-volatile storage of computer-executable instructions and other data. The memory 412 and the data storage 418, removable and/or non-removable, are examples of computer-readable storage media (CRSM) as that term is used herein.

The data storage 418 may store computer-executable code, instructions, or the like that may be loadable into the memory 804 and executable by the processor(s) 410 to cause the processor(s) 410 to perform or initiate various operations. The data storage 418 may additionally store data that may be copied to memory 412 for use by the processor(s) 410 during the execution of the computer-executable instructions. Moreover, output data generated as a result of execution of the computer-executable instructions by the processor(s) 410 may be stored initially in memory 412 and may ultimately be copied to data storage 418 for non-volatile storage.

More specifically, the data storage 418 may store one or more operating systems (O/S) 422; one or more database management systems (DBMS) 424 configured to access the memory 412 and/or one or more of the data stores 406; and one or more program modules, applications, engines, computer-executable code, scripts, or the like such as, for example, one or more clustering modules 426, one or more model generation modules 428, and one or more contract optimization modules 430. Any of the components depicted as being stored in data storage 418 may include any combination of software, firmware, and/or hardware. The software and/or firmware may include computer-executable instructions (e.g., computer-executable program code) that may be loaded into the memory 412 for execution by one or more of the processor(s) 410 to perform any of the operations described earlier in connection with correspondingly named modules.

Although not depicted in FIG. 4, the data storage 418 may further store various types of data utilized by components of the dynamic contract optimization system 402 including any of the data previously described as previously retrieved from the data store(s) 106 and/or the data store(s) 406. Any data stored in the data storage 418 may be loaded into the memory 412 for use by the processor(s) 410 in executing computer-executable instructions. In addition, any data stored in the data storage 418 may potentially be stored in one or more external data stores (e.g., one or more of the data stores 406) and may be accessed via the DBMS 424 and loaded in the memory 412 for use by the processor(s) 410 in executing computer-executable instructions.

The processor(s) 410 may be configured to access the memory 412 and execute computer-executable instructions loaded therein. For example, the processor(s) 410 may be configured to execute computer-executable instructions of the various program modules, applications, engines, or the like of the dynamic contract optimization system 402 to cause or facilitate various operations to be performed in accordance with one or more embodiments of the disclosure. The processor(s) 410 may include any suitable processing unit capable of accepting data as input, processing the input data in accordance with stored computer-executable instructions, and generating output data. The processor(s) 410 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 410 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 410 may be capable of supporting any of a variety of instruction sets.

Referring now to other illustrative components depicted as being stored in the data storage 418, the 0/S 422 may be loaded from the data storage 418 into the memory 412 and may provide an interface between other application software executing on the dynamic contract optimization system 402 and hardware resources of the dynamic contract optimization system 402. More specifically, the 0/S 422 may include a set of computer-executable instructions for managing hardware resources of the dynamic contract optimization system 402 and for providing common services to other application programs (e.g., managing memory allocation among various application programs). In certain example embodiments, the 0/S 422 may control execution of one or more of the program modules depicted as being stored in the data storage 418. The O/S 422 may include any operating system now known or which may be developed in the future including, but not limited to, any server operating system, any mainframe operating system, or any other proprietary or non-proprietary operating system.

The DBMS 424 may be loaded into the memory 412 and may support functionality for accessing, retrieving, storing, and/or manipulating data stored in the memory 412, data stored in the data storage 418, and/or data stored in the data store(s) 406. The DBMS 424 may use any of a variety of database models (e.g., relational model, object model, etc.) and may support any of a variety of query languages. The DBMS 424 may access data represented in one or more data schemas and stored in any suitable data repository. The data store(s) 406 that may be accessible by the dynamic contract optimization system 402 via the DBMS 424 may include, but are not limited to, databases (e.g., relational, object-oriented, etc.), file systems, flat files, distributed datastores in which data is stored on more than one node of a computer network, peer-to-peer network datastores, or the like. The data store(s) 406 may store various types of data including, without limitation, any of the types of data previously described. It should be appreciated that, in certain example embodiments, any external data store and/or any of the data residing thereon may additionally, or alternatively, be stored locally in the data storage 418.

Referring now to other illustrative components of the dynamic contract optimization system 402, the input/output (I/O) interface(s) 414 may facilitate the receipt of input information by the dynamic contract optimization system 402 from one or more I/O devices as well as the output of information from the dynamic contract optimization system 402 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the dynamic contract optimization system 402 or may be separate. The I/O devices may further include, for example, any number of peripheral devices such as data storage devices, printing devices, and so forth.

The I/O interface(s) 414 may also include an interface for an external peripheral device connection such as universal serial bus (USB), FireWire, Thunderbolt, Ethernet port or other connection protocol that may connect to one or more networks. The I/O interface(s) 414 may also include a connection to one or more antennas to connect to one or more networks via a wireless local area network (WLAN) (such as Wi-Fi) radio, Bluetooth, and/or a wireless network radio, such as a radio capable of communication with a wireless communication network such as a Long Term Evolution (LTE) network, WiMAX network, 3G network, etc.

The dynamic contract optimization system 402 may further include one or more network interfaces 416 via which the dynamic contract optimization system 402 may communicate with any of the other system(s) 404 including any platforms, networks, devices, and so forth. The network interface(s) 416 may enable communication, for example, with the other system(s) 404 via one or more of the network(s) 408.

It should be appreciated that the engines depicted in FIG. 4 as being stored in the data storage 418 are merely illustrative and not exhaustive and that processing described as being supported by any particular module may alternatively be distributed across multiple engines, modules, or the like, or performed by a different engine, module, or the like. In addition, various program module(s), script(s), plug-in(s), Application Programming Interface(s) (API(s)), or any other suitable computer-executable code hosted locally on the dynamic contract optimization system 402 and/or hosted on other computing device(s) accessible via one or more of the network(s) 408, may be provided to support functionality provided by the modules depicted in FIG. 4 and/or additional or alternate functionality. Further, functionality may be modularized differently such that processing described as being supported collectively by a collection of modules depicted in FIG. 4 may be performed by a fewer or greater number of program modules, or functionality described as being supported by any particular module may be supported, at least in part, by another module. In addition, engines that support the functionality described herein may form part of one or more applications executable across any number of computing devices of the dynamic contract optimization system 402 in accordance with any suitable computing model such as, for example, a client-server model, a peer-to-peer model, and so forth. In addition, any of the functionality described as being supported by any of the modules depicted in FIG. 4 may be implemented, at least partially, in hardware and/or firmware across any number of devices.

It should further be appreciated that the dynamic contract optimization system 402 may include alternate and/or additional hardware, software, or firmware components beyond those described or depicted without departing from the scope of the disclosure. More particularly, it should be appreciated that software, firmware, or hardware components depicted as forming part of the dynamic contract optimization system 402 are merely illustrative and that some components may not be present or additional components may be provided in various embodiments. While various illustrative modules have been depicted and described as software modules stored in data storage 418, it should be appreciated that functionality described as being supported by the modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality.

One or more operations of the method 200 may be performed by a dynamic contract optimization system 402 having the illustrative configuration depicted in FIG. 4, or more specifically, by one or more program modules, engines, applications, or the like executable on such a device. It should be appreciated, however, that such operations may be implemented in connection with numerous other device configurations.

The operations described and depicted in the illustrative method 200 of FIG. 2 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIG. 2 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular system, system component, device, or device component may be performed by any other system, device, or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like may be additionally based on one or more other operations, elements, components, data, or the like. Accordingly, the phrase “based on,” or variants thereof, should be interpreted as “based at least in part on.”

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for determining optimized terms of a long-term contract for a product, the method comprising:
receiving, from a buyer, a quote request for the long-term contract to purchase the product from a seller;
determining a buyer segment to which the buyer belongs;
determining a spot market price forecast model that forecasts a spot market price of the product on a spot market;
determining a demand forecast model;
determining a contract optimization model based at least in part on the spot market price forecast model and the demand forecast model;
determining the optimized terms of the long-term contract using the contract optimization model, wherein the optimized terms include at least an optimized price, a minimum buyer quantity commitment, and one or more risk-aware contract terms; and
sending an indication of the optimized terms to the buyer.

2. The computer-implemented method of claim 1, wherein the buyer is a first buyer, the method further comprising:
segmenting a set of buyers into a plurality of buyer segments including the buyer segment;
determining that a second buyer belongs with the buyer segment; and
determining that the first buyer and the second buyer share one or more common attributes,
wherein the first buyer is determined to belong to the buyer segment based at least in part on the second buyer belonging to the buyer segment and the first buyer and the second buyer sharing the one or more common attributes.

3. The computer-implemented method of claim 1, further comprising:
determining the optimized price based at least in part on the minimum buyer quantity committment.

4. The computer-implemented method of claim 1, further comprising:
determining a risk model indicative of price fluctuations in the spot market;
determining that the optimized price should be updated based at least in part on an evaluation of the risk model; and
determining an updated optimized price for the long-term contract based at least in part on a respective spot market price associated with the product during each of one or more time periods.

5. The computer-implemented method of claim 4, wherein determining that the optimized price should be updated comprises determining that the respective spot market price associated with the product for at least one time period of the one or more time periods is below a threshold value.

6. The computer-implemented method of claim 4, wherein determining that the optimized price should be updated comprises evaluating the risk model to determine that a concave decrease or a convex decrease has occurred in the spot market price.

7. The computer-implemented method of claim 1, wherein determining the demand forecast model comprises determining an impact of a price influencer on a trajectory of future spot market prices of the product forecasted by the spot market price forecast model.

8. A system for determining optimized terms of a long-term contract for a product, the system comprising:
at least one memory storing computer-executable instructions; and
at least one processor configured to access the at least one memory and execute the computer-executable instructions to:
receive, from a buyer, a quote request for the long-term contract to purchase the product from a seller;
determine a buyer segment to which the buyer belongs;
determine a spot market price forecast model that forecasts a spot market price of the product on a spot market;
determine a demand forecast model;
determine a contract optimization model based at least in part on the spot market price forecast model and the demand forecast model;
determine the optimized terms of the long-term contract using the contract optimization model, wherein the optimized terms include at least an optimized price, a minimum buyer quantity commitment, and one or more risk-aware contract terms; and
send an indication of the optimized terms to the buyer.

9. The system of claim 8, wherein the buyer is a first buyer, and wherein the at least one processor is further configured to execute the computer-executable instructions to:
segment a set of buyers into a plurality of buyer segments including the buyer segment;
determine that a second buyer belongs with the buyer segment; and
determine that the first buyer and the second buyer share one or more common attributes,
wherein the first buyer is determined to belong to the buyer segment based at least in part on the second buyer belonging to the buyer segment and the first buyer and the second buyer sharing the one or more common attributes.

10. The system of claim 8, wherein the at least one processor is further configured to execute the computer-executable instructions to:
determine the optimized price based at least in part on the minimum buyer quantity committment.

11. The system of claim 8, wherein the at least one processor is further configured to execute the computer-executable instructions to:
determine a risk model indicative of price fluctuations in the spot market;
determine that the optimized price should be updated based at least in part on an evaluation of the risk model; and
determine an updated optimized price for the long-term contract based at least in part on a respective spot market price associated with the product during each of one or more time periods.

12. The system of claim 11, wherein the at least one processor is configured to determine that the optimized price should be updated by executing the computer-executable instructions to determine that the respective spot market price associated with the product for at least one time period of the one or more time periods is below a threshold value.

13. The system of claim 11, wherein the at least one processor is configured to determine that the optimized price should be updated by executing the computer-executable instructions to evaluate the risk model to determine that a concave decrease or a convex decrease has occurred in the spot market price.

14. The system of claim 8, wherein the at least one processor is configured to determine the demand forecast model by executing the computer-executable instructions to determine an impact of a price influencer on a trajectory of future spot market prices of the product forecasted by the spot market price forecast model.

15. A computer program product for determining optimized terms of a long-term contract for a product, the computer program product comprising a non-transitory storage medium readable by a processing circuit, the storage medium storing instructions executable by the processing circuit to cause a method to be performed, the method comprising:
receiving, from a buyer, a quote request for the long-term contract to purchase the product from a seller;
determining a buyer segment to which the buyer belongs;
determining a spot market price forecast model that forecasts a spot market price of the product on a spot market;
determining a demand forecast model;
determining a contract optimization model based at least in part on the spot market price forecast model and the demand forecast model;
determining the optimized terms of the long-term contract using the contract optimization model, wherein the optimized terms include at least an optimized price, a minimum buyer quantity commitment, and one or more risk-aware contract terms; and
sending an indication of the optimized terms to the buyer.

16. The computer program product of claim 15, wherein the buyer is a first buyer, the method further comprising:
segmenting a set of buyers into a plurality of buyer segments including the buyer segment;
determining that a second buyer belongs with the buyer segment; and
determining that the first buyer and the second buyer share one or more common attributes,
wherein the first buyer is determined to belong to the buyer segment based at least in part on the second buyer belonging to the buyer segment and the first buyer and the second buyer sharing the one or more common attributes.

17. The computer program product of claim 15, the method further comprising:
determining the optimized price based at least in part on the minimum buyer quantity commitment.

18. The computer program product of claim 15, the method further comprising:
determining a risk model indicative of price fluctuations in the spot market;
determining that the optimized price should be updated based at least in part on an evaluation of the risk model; and
determining an updated optimized price for the long-term contract based at least in part on a respective spot market price associated with the product during each of one or more time periods.

19. The computer program product of claim 18, wherein determining that the optimized price should be updated comprises determining that the respective spot market price associated with the product for at least one time period of the one or more time periods is below a threshold value.

20. The computer program product of claim 18, wherein determining that the optimized price should be updated comprises evaluating the risk model to determine that a concave decrease or a convex decrease has occurred in the spot market price.
